(19) United States
(12) Patent Application Publication
(10) Pub. No.: US 2008/0154016 A1
(43) Pub. Date: Jun. 26, 2008

(54) Polyurethane Dispersion for Composite Film Lamination

(75) Inventors: Andre Burghardt, Bobenheim-Roxheim (DE); Hans-Joachim Fricke, Dirmstein (DE); Karl Haberle, Speyer (DE); Oliver Hartz, Limburgerhof (DE); Horst Seibert, Fussgonheim (DE); Karl-Heinz Schumacher, Neustadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/815,335

(22) PCT Filed: Feb. 14, 2006
(86) PCT No.: PCT/EP2006/050909

§ 371 Date: Aug. 2, 2007

(30) Foreign Application Priority Data
Feb. 15, 2005 (DE) 10 2005 006 984.3

(51) Int. Cl. C08G 63/00; C08G 73/00

(52) U.S. Cl. 528/363; 528/367

(57) ABSTRACT

An aqueous dispersion comprising a polyurethane synthesized from
a) organic diisocyanates
b) dihydroxy compounds having a molar weight of 500 to 5000 g/mol and comprising no ionic group or group that can be converted to an ionic group
c) mono- to trihydric alcohols additionally comprising an ionic group
d) if appropriate, further compounds other than a) to c),
   wherein
   the polyurethane comprises less than 0.6% by weight of urea groups (calculated with a molar weight of 56 g/mol),
   the ionic group of c) has been at least partly neutralized with an alkali metal cation, and
   the reaction of compounds a), b), c), and d) does not take place in the presence of a catalyst containing a metal-carbon bond.

The invention relates to an aqueous dispersion comprising a polyurethane synthesized from
a) organic diisocyanates
b) dihydroxy compounds having a molar weight of 500 to 5000 g/mol and comprising no ionic group or group that can be converted to an ionic group
c) mono- to trihydric alcohols additionally comprising an ionic group
d) if appropriate, further compounds other than a) to c),
   wherein
   the polyurethane comprises less than 0.6% by weight of urea groups (calculated with a molar weight of 56 g/mol),
   the ionic group of c) has been at least partly neutralized with an alkali metal cation, and the reaction of compounds a), b), c), and d) does not take place in the presence of a catalyst containing a metal-carbon bond.

The invention further relates to the use of a dispersion as a laminating adhesive, in particular as a one-component (1K) laminating adhesive. With 1K laminating adhesives, in contrast to 2K laminating adhesives, no crosslinker is added.

Laminating adhesives are used, for example, to produce composite film (composite-film lamination).

As a result of the bonding or laminating of films and foils made from different materials, properties of those materials are combined. The aim of such a measure may be to achieve particular decorative effects or to bring about technical effects such as protection of an imprint, production of boil-resistant film composites, prevention of vapor diffusion, heat-sealability, reliable avoidance of porosity, or stability with regard to aggressive products. The film materials used essentially are polyethylene, polypropylene, especially biaxially oriented polypropylene, polyamide, polyester, PVC, cellulose acetate, cellophane, and metals such as tin or aluminum.

Particular requirements are imposed on the strength of the film composites.

EP-A 441 196 discloses 1K polyurethane dispersions. DE-A 43 08 079 describes the use of 1K polyurethane dispersions as laminating adhesives.

The strength of the composite films that is achieved with the 1K polyurethane dispersions described to date is still not sufficient, particularly in the case of film laminates comprising biaxially oriented polypropylene (OPP), and film laminates comprising OPP films and printed polyester films.

It was therefore an object of the present invention to provide polyurethane dispersions which, when used as laminating adhesive, result in higher strength of the film composites.

Found accordingly have been the polyurethane dispersion defined at the outset and its use.

The polyurethane has been synthesized from
a) organic diisocyanates
b) dihydroxy compounds having a molar weight of 500 to 5000 g/mol and comprising no ionic group or group that can be converted to an ionic group
c) mono- to trihydric alcohols additionally comprising an ionic group, and
d) if appropriate, further compounds other than a) to c).

Diisocyanates a) deserving of mention are, in particular, diisocyanates X(NCO)₂, where X is an aliphatic hydrocarbon radical having 4 to 15 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis, and the cis/trans isomer, and mixtures of these compounds.

Diisocyanates of this kind are available commercially.

As mixtures of these isocyanates, particular importance attaches to the mixtures of the respective structural isomers of diisocyanatotoluene and of diisocyanatodiphenylmethane; the mixture of 80 mol % 2,4-diisocyanatotoluene and 20 mol % 2,6-diisocyanatotoluene is particularly appropriate. Further of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, the preferred mixing ratio of the aliphatic to the aromatic isocyanates being 4:1 to 1:4.

The dihydroxy compounds b) can be polyesterpolyols, which are known, for example, from Ullmanns Encyklopädie der technischen Chemie, 4th Edition, Volume 19, pp. 62 to 65. Preference is given to using polyesterpolyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyesterpolyols. The polycarboxylic acids may be aliphatic, cycloaliphatic, araliphatic, aromatic or heterocyclic and if appropriate may be substituted, by halogen atoms for example, and/or unsaturated. Examples that may be mentioned thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preference is given to dicarboxylic acids of the general formula HOOC—(CH₂)_{y}—COOH, where y is a number from 1 to 20, preferably an even number from 2 to 20, e.g., succinic acid, adipic acid, sebacic acid, and dodecanedicarboxylic acid.

Examples of suitable dihydric alcohols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference extends to neopentyl glycol.

Also suitable, furthermore, are, if appropriate, polycarbonate-diols, such as may be obtained, for example, by reacting phosgene with an excess of the low molecular mass alcohols specified as synthesis components for the polyesterpolyols.

If appropriate it is also possible to use lactone-based polyesterdiols, which are homopolymers or copolymers of lactones, preferably adducts of lactones, containing terminal hydroxyl groups, with suitable difunctional starter molecules. Suitable lactones are preferably those deriving from compounds of the general formula HO—(CH₂)_{z}—COOH, where z is a number from 1 to 20 and where an H atom of a methylene unit may also have been substituted by a C₁ to C₄ alkyl radical. Examples are ε-caprolactone, β-propiolactone, γ-butyrolactone and/or methyl-γ-caprolactone, and mixtures thereof. Suitable starter components are, for example, the low molecular mass dihydric alcohols specified above as a synthesis component for the polyester polyols. The corresponding polymers of ε-caprolactone are particularly preferred. Lower polyesterdiols or polyetherdiols as well can be used as starters for preparing the lactone polymers. In lieu of the polymers of lactones it is also possible to use the corresponding, chemically equivalent polycondensates of the hydroxy carboxylic acids corresponding to the lactones.

Polyetherdiols are obtainable in particular by polymerizing ethylene oxide, propylene oxide, butylene oxide, tetrahydrofuran, styrene oxide or epichlorohydrin with itself, in the presence, for example, of BF₃, or by addition reactions of these compounds, if appropriate as a mixture or in succession, with starting components containing reactive hydrogen atoms, such as alcohols or amines, e.g., water, ethylene glycol, propane-1,2-diol, propane-1,3-diol, 2,2-bis(4-hydroxyphenyl)propane or aniline.

Preferred compounds b) are polyetherols. In particular at least 50%, more preferably at least 85%, very preferably at least 95%, or 100% by weight of the compounds b) are polyetherols. The molecular weight of the compounds b) is preferably 1000 to 3000 g/mol. This is the number-average molecular weight, determined by the number of end groups (OH number).

The monohydric to trihydric alcohols c) comprise, in particular, anionic groups such as the sulfonate, the carboxylate, and the phosphate group. The term “ionic group” is also intended to embrace those groups which can be converted to ionic groups. Accordingly, carboxylic acid, sulfonic acid, or phosphoric acid groups are also interpreted as being ionic groups.

Suitability is possessed customarily by aliphatic, cycloaliphatic, araliphatic or aromatic carboxylic acids and sulfonic acids which carry at least one alcoholic hydroxyl group. Preference is given to dihydroxy carboxylic acids, especially dihydroxyalkylcarboxylic acids, especially those having 3 to 10 carbon atoms, such as are also described in U.S. Pat. No. 3,412,054. Particularly preferred compounds are those of the general formula (c₁)

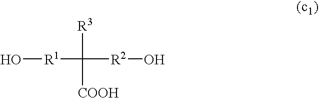

in which R¹ and R² are each a C₁ to C₄ alkanediyl (unit) and R³ is a C₁ to C₄ alkyl (unit), and especially dimethylolpropionic acid (DMPA).

Besides compounds a), b), and c), further compounds, compounds d), are suitable as synthesis components of the polyurethane.

Mention may be made, for example, of isocyanate compounds having more than two isocyanate groups, such as are obtainable, for example, by the formation of biurets or isocyanurates from the above diisocyanates.

Mention may further be made of compounds having a molar weight of less than 500 g/mol which comprise at least two isocyanate-reactive groups, especially hydroxyl groups. Compounds of this kind serve preferably for chain extension or crosslinking.

Suitable compounds include, for example, ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference extends to neopentyl glycol.

Mention may also be made of compounds d) having only one isocyanate group or one isocyanate-reactive group, particularly monoalcohols. Compounds of this kind are usually used to regulate the molecular weight.

Preferably the polyurethane is composed to an extent of at least 50%, more preferably at least 80%, and very preferably at least 90% by weight of compounds a) and b).

The fraction of components c) as a proportion of the total amount of components (a), (b), (c), and (d) is generally such that the molar amount of the ionic groups, based on the amount by weight of all monomers (a) to (d), is 30 to 1000, preferably 50 to 800, and more preferably 80 to 600 mmol/kg of polyurethane.

The amount of compounds d) is preferably less than 10%, more preferably less than 5% or 2%, and very preferably less than 1% by weight. In one particularly preferred embodiment the polyurethane is composed exclusively of a), b), and c).

Substantial features of the polyurethane of the invention are that
the amount of urea groups (molar weight 56 g/mol)

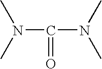

is less than 0.6% by weight, based on the total weight of the polyurethane,
the ionic group of c) has been at least partly neutralized with alkali metal cations, and
the reaction of the compounds a), b), c), and d) does not take place in the presence of a catalyst containing metal-carbon bonds.

The amount of urea groups is preferably less than 0.5%, more preferably less than 0.4% by weight.

Urea groups are formed during reaction of isocyanate groups with amino groups. Compounds d) containing amino groups are therefore used, if at all, only in minor amounts.

With very particular preference the polyurethane is largely free of urea groups.

The ionic groups of c) have been neutralized preferably to an extent of at least 20 mol %, more preferably at least 30 mol %, very preferably at least 50 mol %, with an alkali metal cation, and hence are in the form of the salt of the corresponding alkali metal cation. In particular, 20 to 80 mol %, more preferably 30 to 70 mol %, of the ionic groups c) have been neutralized with an alkali metal cation. The neutralization may be carried out using alkali metal hydroxides, alkali metal carbonates, and alkali metal hydrogen carbonates. Alkali metal hydroxides are preferred.

As alkali metal hydroxides, mention may be made in particular of NaOH and KOH. NaOH is particularly preferred.

Organometallic compounds (i.e., compounds containing a metal-carbon bond), particularly organotin compounds such as dibutyltin dilaurate, are often used as catalysts in the reaction of isocyanate with hydroxyl groups.

In the context of the present invention, no such catalysts containing a metal-carbon bond are used during the reaction.

In particular, no compounds comprising metal atoms, whether in covalently bonded form or in ionic form, are used as catalysts.

It is preferred to use neither metallic catalysts nor other catalysts in the reaction of isocyanate compounds with compounds comprising hydroxyl groups.

Normally, the components (a) to (d) and their respective molar amounts are selected such that the ratio A:B, where
A is the molar amount of isocyanate groups and
B is the sum of the molar amount of hydroxyl groups and the molar amount of functional groups which can react with isocyanates in an addition reaction,
   is 0.5:1 to 2:1, preferably 0.8:1 to 1.5, more preferably 0.9:1 to 1.2:1. With very particular preference the A:B ratio is as close as possible to 1:1.

The monomers (a) to (d) used carry on average usually 1.5 to 2.5, preferably 1.9 to 2.1, more preferably 2.0 isocyanate groups and/or functional groups which can react with isocyanates in an addition reaction.

The polyaddition of components (a) to (d) to prepare the polyurethane takes place preferably at reaction temperatures of up to 180° C., preferably up to 150° C. under atmospheric pressure or under the autogenous pressure.

The preparation of polyurethanes, and of aqueous polyurethane dispersions, is known to the skilled worker.

The aqueous polyurethane dispersions obtained generally have a solids content of 10% to 70%, preferably of 15% to 50% by weight.

The polyurethanes have a K value in N,N-dimethylformamide (DMF, 21° C.) of generally from 20 to 80.

The K value is a relative viscosity number which is determined in analogy to DIN 53 726 at 25°. It comprises the flow rate of a 1% strength by weight solution of polyurethane in DMF relatively to the flow rate of pure DMF, and characterizes the average molecular weight of the polyurethane.

The polyurethane dispersions can be used without further adjuvants as an adhesive or sealant.

The adhesives or sealants of the invention comprise the polyurethane dispersions and, if appropriate, further constituents. The adhesives may be pressure-sensitive adhesives, contact adhesives (double-sided adhesive application), foam adhesives (adhesive comprises foaming agents) or laminating adhesives, including those for automotive interior components, for example.

Examples of suitable substrates for bonding include those of wood, metal, plastic, and paper.

Further constituents for nomination include, for example, thickeners, plasticizers, or else tackifying resins such as, for example, natural resins or modified resins such as rosin esters, or synthetic resins such as phthalate resins. The adhesives preferably comprise no compounds which react with the polyurethane with crosslinking. Accordingly, the polyurethane dispersions of the invention are used preferably as one component (1K) adhesives, particularly as 1K laminating adhesives.

The laminating adhesive utility generally involves the bonding of two-dimensional substrates, films or foils for example, to paper or card. The polyurethane dispersions are particularly suitable as an adhesive for producing composite films, where, as already described at the outset, different films or foils are bonded to one another for various purposes.

The film and foil materials essentially employed are polyethylene, polypropylene, especially biaxially oriented polypropylene (OPP), polyamide, polyesters, PVC, cellulose acetate, cellophane, and metals such as tin and aluminum, also including, in particular, metallized polymer films, e.g., metallized polyolefin films or polyester films.

The polymer films, especially polyolefin films, may if appropriate have been corona-pretreated. The laminating adhesive is applied to at least one, generally only one, of the substrates to be bonded. The coated substrates are generally dried briefly and then pressed against one another or against uncoated substrates, preferably at a temperature of 30 to 80° C.

The resulting bonded assembly, in particular the film composite obtained, has a high bond strength at room temperature, of a kind otherwise achievable generally only in the case of two-component systems with use of a crosslinker.

A particularly high strength is achieved in connection with the bonding of polyolefin films, including in particular printed polyolefin films, OPP films, for example, to one another or in connection with the bonding of polyolefin films of this kind to metallized polyester films. Preferably at least one of the polyolefin films carries print.

At high temperatures above about 60° C., the bond strength becomes lower. Above about 100° C., in boiling water for example, the bonds can generally be separated again effectively. This allows separate recycling of the different foils or films in the composite.

### EXAMPLES

### Example 1

### Synthesis of a Polyurethane Dispersion of the Invention

A mixture of 174.2 g (1.00 mol) of diisocyanatotoluene (80% 2,4 isomer, 20% 2,6 isomer), 800 g (0.40 mol) of polypropylene glycol with an OH number of 56, 80.3 g (0.60 mol) of dimethylolpropionic acid and 100 g of acetone was reacted at 95° C. for five hours. It was then cooled to 30° C. and the amount of unreacted NCO groups was found to be 0.06% by weight. Thereafter it was diluted with 800 g of acetone and then, in succession, a solution of 9.6 g (0.24 mol) of sodium hydroxide in 90 g of water, and 1500 g of water were incorporated with stirring. Distillation of the acetone gave an aqueous polyurethane dispersion with a concentration of approximately 40% by weight.

### Comparative Example 1

### Synthesis of a Polyurethane Dispersion According to DE-A1 4 308 079

A mixture of 174.2 g (1.00 mol) of diisocyanatotoluene (80% 2,4 isomer, 20% 2,6 isomer), 800 g (0.40 mol) of polypropylene glycol with an OH number of 56, 80.3 g (0.60 mol) of dimethylolpropionic acid, 0.4 g of dibutyltin dilaurate and 100 g of acetone was reacted at 95° C. for five hours. It was then cooled to 30° C. and the amount of unreacted NCO groups was found to be 0.07% by weight. Thereafter it was diluted with 800 g of acetone and then, in succession, 24.2 g (0.24 mol) of triethylamine, and 1500 g of water were incorporated with stirring. Distillation of the acetone gave an aqueous polyurethane dispersion with a concentration of approximately 40% by weight.

### Production of Composite Films

The polyurethane dispersion was applied at a rate of 4 g/m² to a corona-pretreated film made from printed, biaxially oriented polypropylene (OPP), using a 0.2 mm roller doctor. The coated films were dried with a hot air fan for about 2 minutes and pressed against a metallized polyester film in a roller press at 70° C. and 6.5 bar, with a speed of 5 m/min.

After different storage times at room temperature, the peel strength, in N/cm, of the film composite was determined using a tensile testing machine:

Printed oPP/metallized polyester film composite

| Storage time | Instantaneous | 24 hours | 7 days |
|---|---|---|---|
| Inventive | 0.82 | 1.60 | 1.87 |
| Comparative | 0.79 | 1.10 | 1.23 |

1. An aqueous dispersion comprising a polyurethane synthesized from
a) organic diisocyanates
b) dihydroxy compounds having a molar weight of 500 to 5000 g/mol and comprising no ionic group or group that can be converted to an ionic group
c) mono- to trihydric alcohols additionally comprising an ionic group and
d) if appropriate, further compounds other than a) to c),
wherein
the polyurethane comprises less than 0.6% by weight of urea groups (calculated with a molar weight of 56 g/mol),
the ionic group of c) has been at least partly neutralized with an alkali metal cation, and
the reaction of compounds a), b), c), and d) does not take place in the presence of a catalyst containing a metal-carbon bond.

2. The aqueous dispersion according to claim 1, wherein compounds b) are poly-ether alcohols.

3. The aqueous dispersion according to claim 1, wherein compounds c) are dihydroxy carboxylic acids.

4. The aqueous dispersion according to claim 1, comprising no compound containing a metal-carbon bond.

5. The aqueous dispersion according to claim 1, comprising no crosslinkers.

6. A method of producing an adhesive comprising admixing a dispersion according to claim 1 to other materials.

7. A method of producing a one-component (1K) adhesive comprising admixing a dispersion according to claim 1 to other materials.

8. A method of producing a composite-film lamination comprising admixing a dispersion according to claim 1 to other materials.

9. A method of producing a bonding polyolefin films to one another comprising admixing a dispersion according to claim 1 to other materials.
